(19) United States
(12) Patent Application Publication
(10) Pub. No.: US 2026/0050243 A1
(43) Pub. Date: Feb. 19, 2026

(54) Method for Operating a Conveyor System, and Conveyor System

(71) Applicant: Bayerische Motoren Werke Aktiengesellschaft, Muenchen (DE)

(72) Inventors: Oliver MRASEK, Regensburg (DE); Peter WEIDERER, Muenchen (DE)

(21) Appl. No.: 19/102,041

(22) PCT Filed: Sep. 27, 2023
(86) PCT No.: PCT/EP2023/076710

§ 371 Date: Feb. 7, 2025

(30) Foreign Application Priority Data
Oct. 12, 2022 (DE) 10 2022 126 566.8

(51) Int. Cl. G05B 13/02; B65G 43/02

(52) U.S. Cl. CPC G05B 13/0265; B65G 43/02; B65G 2203/0266

(57) ABSTRACT

A method for operating a conveyor system, in which assembly line trays, which each serve to hold a component, can be conveyed (moved) along a conveyor line by stationary conveyor elements, said method comprising: recording a respective conveying moment for the respective conveyor while conveying the respective assembly line trays; recording at least one respective parameter value by a sensor device for the respective conveyor element at the respective conveying moment; forming a respective data telegram for the respective conveyor element at the respective conveying moment by a respective control device of the respective conveyor element: compiling the data telegrams into a dataset by a central electronic computing device; evaluating the dataset by an anomaly model; if the evaluation reveals that an anomaly of at least one of the parameter values is above a threshold value, issuing a service instruction.

### BACKGROUND AND SUMMARY

The present disclosure relates to a method for operating a conveyor system and a conveyor system, in accordance with the independent claim.

Conveyor systems are often used in assembly and production. Various conveyor systems and conveying techniques can thus be used for assembling a vehicle. For example, a conveyor system comprises assembly line trays. In this case, the assembly line trays do not have their own drive but are moved along rails by stationary conveyor elements.

The respective conveyor element thus comprises a drive and, for example, a drive wheel. The assembly line trays are held and guided on the rails in this case by guide rollers. The assembly line trays are typically used to transport vehicles or vehicle components, in particular the vehicle body, above floor level, while assembly work is performed thereon. The component is removed from the assembly line tray close to an end point or reversal point of a conveying path and the assembly line tray can be transported back, in particular below floor level. The assembly line trays are conveyed by multiple stationary or fixed conveyor elements. These conveyor elements form drives, which are mounted so as to be stationary and move the assembly line tray by a drive wheel.

A malfunction of one of the conveyor elements or an assembly line tray may generally lead to a stoppage of the conveying system, which may be associated with high costs in vehicle production.

EP 1 800 196 BI discloses an apparatus for predicting the average period of time between two malfunctions of a technical system.

A disadvantage of the prior art is that, for example, a current state of the conveyor system is unknown and therefore it is not possible to predict irregularities or an imminent malfunction.

It is an object of the present disclosure to provide a method and a conveyor system by which a malfunction of a conveyor element of the conveyor system can be prevented in a particularly advantageous manner.

This object is achieved according to the present disclosure by the subjects of the independent patent claims. Advantageous embodiments are the subject matter of the independent patent claims and the description.

A first aspect of the present disclosure relates to a method for operating a conveyor system, in which assembly line trays, each of which are used to hold a component, are configured to be conveyed or moved along a conveying path by stationary conveyor elements. The conveying path of the conveyor system may form, in particular, a closed circuit, which runs above floor level for transporting the components, and, for example, runs along assembly points at which the component—in particular a vehicle body component—is processed. In order to convey or move the respective assembly line tray back to the beginning, part of the conveying path may be situated below floor level.

In order to enable the prevention of a malfunction of the conveyor system in a particularly advantageous manner, the method according to the present disclosure comprises:

In a first step, a respective conveying time for the respective conveyor device during a conveying process of the respective assembly line tray, or each one of the assembly line trays, is measured. The respective conveyor element comprises, in particular, a respective drive, which, for example, drives a drive wheel, which conveys the assembly line tray along a track system when it is in contact therewith. A certain time interval passes at a certain time at least while a respective one of the assembly line trays is conveyed along the conveying path by the currently conveying conveyor element. In other words, in the first step of the method, it is thus recorded when and/or how long which assembly line tray has been conveyed on which conveyor element. In this case, the time, that is to say the conveying time, measured or recorded here may characterize or describe, in particular, the end of the conveying process.

In a second step of the method according to the present disclosure, a sensor device measures, for the respective conveyor element for the respective conveying time, at least one respective parameter value, which characterizes a state of the respective conveyor element and/or the assembly line tray conveyed by the respective conveyor element during the conveying process. In other words, in each conveying process in particular of each assembly line tray at each of the conveyor elements or at a plurality of conveyor elements of the conveyor systems to be monitored, a parameter value or a measurement value and thus a parameter is measured by a sensor device that is suitable for the measured measurement variable, which sensor device can characterize or describe the associated conveyor element and/or the currently conveyed assembly line tray.

In a third step, a respective control device of the respective conveyor element, which control device is in particular in the form of a programmable logic control device, forms a respective data telegram or data block for the respective conveyor element at the respective conveying time, the data telegram or data block comprising the at least one respective parameter value, the conveying time, an assembly line tray ID of the respectively conveyed assembly line tray, that is to say an assembly line tray identification nunber or identification feature, and a conveyor element ID of the respective conveyor element, that is to say a conveyor element identification number or identification feature. In other words, a data packet that measures the at least one respective parameter value and thus contains both the time and an identification of the assembly line tray involved in the conveying process or the involved conveyor element is put together or formed for each conveying process of the monitored conveyor elements, such that the data telegram permits unambiguous assigning of the at least one respective parameter value.

In a fourth step, a central electronic computing device compiles the data telegrams to form a dataset. In other words, the respective control device of the respective conveyor element transmits its data telegrams to a central electronic computing device or retrieves the respective data telegrams from the central electronic computing device. The central electronic computing device is used to compile the individual data telegrams to form an overall dataset.

Subsequently, in a fifth step of the method according to the present disclosure, the dataset is evaluated by way of an anomaly model, which is configured to evaluate an anomaly of the respective at least one parameter value of the respective data telegram. In other words, provision is made of an anomaly model that has been trained, for example, by machine learning methods or that is at least generally specialized in identifying differences between the parameter values and a target value or interpreting the dataset so as to identify imminently arising changes in the respective conveyor element and/or the respective assembly line tray that may lead to a malfunction of at least a part of the conveyor system.

In a sixth step, if the evaluation carried out in step 5 reveals that an anomaly of at least one of the parameter values is above a threshold value, a service instruction is issued for the corresponding assembly line tray and/or the corresponding conveyor element that was supplied by the parameter value whose anomaly was identified by the anomaly model or whose parameter value has the anomaly, or for which the parameter value having the anomaly was measured. In other words, in the sixth step, if the anomaly model has ascertained that there is an anomaly in at least one parameter value that has been measured for one of the conveyor elements or one of the assembly line trays or a combination of conveyor element and assembly line tray, an instruction, for example in the form of a signal, is issued for a service robot or a maintenance unit so that monitoring or inventory for the corresponding assembly line tray or the corresponding conveyor element can be initiated or carried out.

The intention of the method is to find conspicuous conveyor elements within the entirety of conveyor elements. In this case, the conveyor elements are each able to be identified by way of their unambiguous conveyor element ID: each conveyor element is thus unique in the set of conveyor elements. To identify a conspicuous conveyor element, the at least one parameter value thereof is compared with other measured parameter values. The method can be used to decide which of the at least one parameter values or which type of parameter value is to be used. The parameter values are subsequently aggregated or recorded. The parameter values may also, for example, be dependent on a standard or a position of the respective conveyor element in the conveyor system. For example, the dataset may be formed for a particular period of time, for example for an hour's operation of the conveyor system, such that the data telegrams present therein are compiled to form the dataset. A dataset with a number n of data telegrams and a number m of at least one measured parameter value may form the input for the anomaly model. In the anomaly model, it is possible to measure a deviation from an average parameter value on the basis of an u by m matrix, for example, as a result of which the anomaly can be identified and, for example, an anomaly frequency can be calculated. In this case, for example, deviations from Gaussian distributions can be ascertained in standard deviations to reveal the anomaly.

The method according to the present disclosure therefore results in multiple advantages. Firstly, targeted prevention of malfunctions of the conveyor system is possible. Furthermore, it is possible to generate meaningful data through the large number of available comparison elements in the form of the parameter values and/or conveyor elements. Furthermore, the method can be applied to different systems and, for example, is independent of the number of conveyor elements and/or assembly line trays.

The method may also be carried out, for example, particularly expediently because it is possible to draw on already present sensor devices for measuring the parameter values, for example. In particular, for example, each of the conveyor elements has its own sensor device, which is used for state monitoring. In addition or as an alternative, parameters or parameter values from quasi arbitrary, installed components can be used, the parameters or parameter values being able to be read out, for example, by the sensor device or an additional sensor device particularly of the respective component, such as the respective control device. These parameter values can thus advantageously be used for the method. Use is also possible irrespective of manufacturer since parameter values of different components can easily be used together for the method according to the present disclosure. Moreover, the method for operating the conveyor system is also suitable as a method for starting up the conveyor system or a new conveyor system since the method may enable a fast reaction to faults arising upon start-up.

In an advantageous configuration of the present disclosure, the dataset and/or an additional dataset is used as a training dataset for the anomaly model, which uses a machine learning method. In other words, the anomaly model is based at least in part on a self-learning algorithm and/or a neural network and is thus formed at least in part as an artificial intelligence system. In this case, the neural network can be trained, for example, by deep learning methods. Training datasets that are, in particular, labeled are used for training a self-leaming algorithm and/or the neural network, that is to say parameter values that have an anomaly are manually marked by a worker in advance, for example. In addition or as an alternative, a second instance of a self-learning algorithm that monitors the training can be used. In other words, the data obtained by the method can be used in the form of data telegrams, which are compiled to form the dataset, in order to train the anomaly model. Furthermore, the anomaly model is advantageously in the form of artificial intelligence. This results in the advantage that the method can be applied particularly efficiently. Furthermore, the method can be applied particularly advantageously to new parameter values.

In another advantageous configuration of the present disclosure, an active current and/or a temperature is measured as the at least one parameter value. In other words, the respective sensor device for measuring the parameter value is configured to measure an active current flowing, in particular, for example, through a drive of the conveyor element and/or a temperature, for example of a bearing on which the assembly line trade is guided. This results in the advantage that the parameter value that permits a particularly precise statement about the anomaly is particularly advantageously measured.

In another advantageous configuration of the present disclosure, the respective conveyor element is used to convey a drive, configured in particular as an electric motor. In other words, the conveyor element is configured in such a way that it has its own drive that is used to convey the assembly line trays and that is preferably in the form of an electric machine operated in motor operation. In this case, the electric machine can be supplied with electrical energy or electric current, for example, via a converter, such that the conveyor element can convey. This results in the advantage that the conveyor system can be operated in a particularly advantageous manner.

In another advantageous configuration of the present disclosure, an average active current and/or a maximum active current and/or a variance of the active current for the respective associated drive is measured for the respective data telegram. In other words, in addition to the parameter value, a type of active current or a variable, which characterizes the active current, of the respective drive is measured or ascertained. In this case, the corresponding measurement of the respective active current can be tapped at a converter of the respective drive, for example. The average active current or the maximum active current or the variance of the active current is restricted in this case, in particular, to the duration of the respective conveying process, that is to say the period of time for the conveying. This results in the advantage that the anomaly model can be evaluated particularly advantageously using relevant information.

In another advantageous configuration of the present disclosure, the respective data telegram goes through preprocessing before or for the compilation of the dataset. In other words, the data telegrams are preprocessed, for example, by a preprocessor or the like, which can sort out, for example, unrealistic parameter values or data telegrams in which data is missing or is incomplete, for example. This results in the advantage that the method can be performed in a particularly advantageous manner and conveyor systems can thus be operated particularly efficiently.

In another advantageous configuration of the present disclosure, during preprocessing, a time interval is set and/or, in the case of multiple parameter values, one of the parameter values is selected and/or targets are set. In other words, the preprocessing is used to set a time interval, which thus determines which data telegrams are retained for the dataset. In addition or as an alternative, if multiple respective parameter values are measured for a conveyor element or a respective conveying process, for example, only certain parameter values are permitted for further processing or for analysis by the anomaly model. In addition or as an alternative, targets may be set, that is to say a decision is made during preprocessing, for example, as to which anomaly or how great an anomaly is to be ascertained. This results in the advantage that the method can be performed particularly efficiently. Furthermore, the conveyor system can be operated in a particularly advantageous manner or can be protected against malfunctions in one of the conveyor elements.

In another advantageous configuration of the present disclosure, the threshold value is adjusted to an anomaly value. In other words, the threshold value that determines the point from which a service instruction is issued is adjusted to an anomaly value, which is calculated or determined in particular by the model and which provides a measure for an anomaly to be tolerated or contains an anomaly score. The threshold value can therefore be adapted, in particular dynamically, to a model that is improved by training data, for example. This results in the advantage that the method can be performed particularly efficiently, and failure safety of the conveyor system becomes particularly great.

A second aspect of the present disclosure relates to a conveyor system having stationary conveyor elements and assembly line trays, which are used to hold a respective component and which can be conveyed by the conveyor elements along a conveying path, wherein the conveyor system can be operated by a method according to the first aspect of the present disclosure.

In this case, advantages and advantageous configurations and developments of the second aspect of the present disclosure can be considered advantages and advantageous configurations and developments of the first aspect of the present disclosure and vice versa.

Further features of the present disclosure become apparent from the claims, the figures and the description of the figures. The features and combinations of features cited in the description hereinabove and the features and combinations of features cited in the description of the figures hereinbelow and/or shown in the figures alone can be used not only in the respectively indicated combination but also in other combinations or on their own without departing from the scope of the present disclosure.

The present disclosure will now be explained in more detail on the basis of an embodiment and with reference to the accompanying drawings.

### BRIEF DESCRIPTION OF THE DRAWINGS

FIG. 1 shows a schematic flowchart of a method for operating a conveyor system; and

FIG. 2 shows a schematic side view of the conveyor system having stationary conveyor elements, which are used to convey assembly line trays along a conveying path.

### DETAILED DESCRIPTION OF THE DRAWINGS

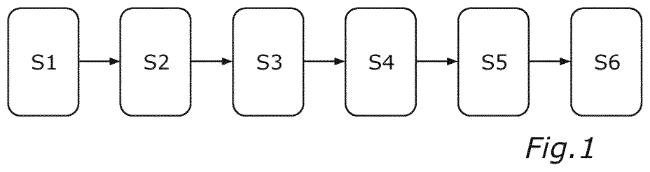

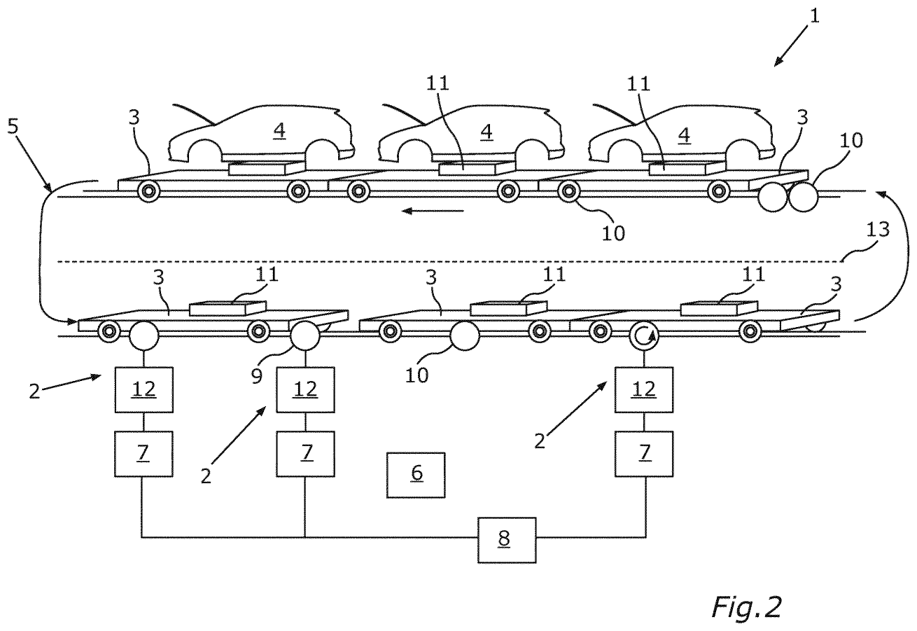

FIG. 1 shows a schematic flowchart of a method for operating a conveyor system 1 shown schematically in FIG. 2. The conveyor system 1 has stationary conveyor elements 2, by which assembly line trays 3, each of which are used to hold a component 4, can be conveyed or moved along a conveying path 5.

The method comprises multiple steps.

In a first step S1, a respective conveying time for the respective conveyor element 2 during a conveying process of the respective assembly line tray 3 is measured. In a second step S2, a sensor device 6 measures, for the respective conveyor element 2 at the respective conveying time, at least one respective parameter value, which characterizes a state of the respective conveyor element and/or the assembly line tray 3 conveyed by the respective conveyor element 2 during the conveying process. In a third step S3, a respective control device 7 of the respective conveyor element 2 forms a respective data telegram for the respective conveyor element 2 at the respective conveying time, the data telegram comprising the at least one respective parameter value, the associated conveying time, an assembly line tray ID of the respectively conveyed assembly line tray 3 and a conveyor element ID of the respectively conveyed conveyor element 2. In a fourth step S4, a central electronic computing device 8 compiles the data telegrams to form a dataset. In a fifth step S5, the dataset is evaluated by way of an anomaly model, which is configured to evaluate an anomaly of the respective at least one parameter value of the respective data telegram. In a sixth step S6, if the evaluation reveals that an anomaly of at least one of the parameter values is above a threshold value, a service instruction is issued for the corresponding assembly line tray 3 and/or the corresponding conveyor element 2 for which the parameter value having the anomaly was or is measured.

The respective conveyor element 2 may have, for example, a respective drive wheel 9, via which the assembly line tray 3 is able to be moved along the conveying path 5. Guide rollers 10 may also be provided to guide the respective assembly line tray 3 along a rail, for example, which forms the conveying path 5. To secure the respective component 4, which, in particular when the conveyor system 1 is used in motor vehicle production, may be in the form of a motor vehicle body, a lifting table 11 may be mounted on the respective assembly line tray 3, for example.

A drive 12, which is shown by way of example in FIG. 2 and which is in the form, in particular, of an electric motor, can advantageously be used.

Particularly when electric motors are used as the drive 12 of the respective conveyor element 2, an active current is advantageously measured as the at least one respective parameter value. In addition or as an alternative, a temperature may be measured as the at least one respective parameter value, for example.

The dashed line in FIG. 2 shows a ground level 13: the components 4 thus transported along the conveying path 5 above ground or above floor level and the empty assembly line trays 3 or the trays not loaded with the component 4 are transported back below floor level or underground. In particular, the conveying path 5 forms a closed circuit.

It may be advantageous for the method if an average active current and/or a maximum active current and/or a variance of the active current for the respective associated drive 12 are measured to form the respective data telegram.

In this case, it is also advantageous, in the or for the generation or compilation of the dataset, if the respective data telegram goes through preprocessing, for example in a preprocessor formed in the electronic computing device 8. In this preprocessing, for example, a time interval that stipulates which data telegrams are present in the dataset can be set. In addition or as an alternative, for example, in the case of multiple parameter values, one of the parameter values can be selected, which can be observed by the anomaly model. This can be carried out, in particular, in addition to or in combination with target setting for which anomaly is advantageously to be revealed during the operation of the conveyor system 1.

In this case, the anomaly model used in the present disclosure is, in particular, a model that uses at least a machine learning method and thus, in particular, is in the form of artificial intelligence or draws on artificial intelligence methods. It is thus possible, for example, to use a self-learning algorithm and/or at least a neural network to evaluate the dataset. In this case, it is advantageous that the dataset and/or an additional dataset is used as the training dataset for the anomaly model, for example by way of manual labeling of the dataset or the anomalies present therein. The anomaly model can particularly advantageously be matched to properties of the conveyor system 1 and it can thus be operated in a particularly advantageous manner. In this case, for example, it may be advantageous if the threshold values adjusted to an anomaly value.

In other words, the method is used to provide a monitoring system, which uses an, in particular continuous, comparison of data and parameters from the respective controller or the respective control device 7 to identify the anomalies of the respective conveyor system or conveyor element 2 and thereby enables introduction of preventative measures. The method and a conveyor device 1, as shown in FIG. 2, thus provide the possibility to have an early warning system for irregularities available. As a result, for example, production stoppages can be prevented since unforeseen malfunctions due to technical faults can be prevented or at least reduced.

The respective control device 7, in particular in the form of a programmable logic controller, of the respective conveyor element 2, which is advantageously arranged below floor level, thus delivers the data telegram, while a respective identifiable assembly line tray 3 is transported by the respective conveyor element 2. This data telegram from the programmable logic controller of a fixed conveyor element 2 contains the information already mentioned and summarized once more in the following text: time, in particular end of the respective conveying process, unambiguous ID of the fixed or stationary conveyor element, unambiguous ID of the conveyed assembly line tray 3. In particular, aggregated parameters during the conveying process, such as an active current, for example. Furthermore, in addition to the average active current, a maximum active current or a variance of the active current can be measured by the converter of the drive 12, in particular for each duration of the conveying process. Owing to the information contained in the data telegram, it is thus possible, for example, to assign the current consumption of a particular fixed conveyor element 2 to the respective conveyed assembly line tray 3. The dataset can be formed from the data telegrams, where this dataset can be preprocessed using process steps, for example on the basis of conspicuous assembly line trays 3 and/or the basis of a comparison of the parameters of the fixed conveyor elements 2 with respect one another and/or on the basis of a parameter value, in particular if respective multiple parameter values are measured for each conveyor element 2, of an averaging over multiple parameter values for each conveyor element 2 or, for example, a time interval in which the parameter values are aggregated. The dataset, which constitutes, in particular, an overall dataset, can thus be formed according to these process steps of preprocessing. This overall dataset forms the input for an anomaly model, in particular in the form of a machine learning model, for the detection of the anomaly. The process dataset could appear as shown in table 1:

| Time (1 h | ID assembly | Fixed | Fixed | | Fixed |
|---|---|---|---|---|---|
| interval) | line tray | conveyor 1 | conveyor 2 | . . . | conveyor N |
| 2021-03-01/ | Assembly line | Mean_1 | Mean_1 | . . . | Mean_1 |
| 10:00:00-2021- | tray 1 | h(mean(active | h(mean(active | | h(mean(active |
| 03-01/11:00:00 | | current)) | current)) | | current)) |
| 2021-03-01/ | Assembly line | Mean_1 | Mean_1 | . . . | Mean_1 |
| 11:00:00-2021- | tray 1 | h(mean(active | h(mean(active | | h(mean(active |
| 03-01/12:00:00 | | current)) | current)) | | current)) |
| . . . | . . . | . . . | . . . | . . . | . . . |
| 2021-03-01/ | Assembly line | Mean_1 | Mean_1 | . . . | Mean_1 |
| 10:00:00-2021- | tray 2 | h(mean(active | h(mean(active | | h(mean(active |
| 03-01/11:00:00 | | current)) | current)) | | current)) |
| 2021-03-01/ | Assembly line | Mean_1 | Mean_1 | . . . | Mean_1 |
| 11:00:00-2021- | tray 2 | h(mean(active | h(mean(active | | h(mean(active |
| 03-01/12:00:00 | | current)) | current)) | | current)) |
| . . . | . . . | . . . | . . . | . . . | . . . |

The, in particular trained, machine learning model or anomaly model is applied to the dataset, as a result of which an anomaly value or an anomaly score can be calculated. In this case, corresponding datasets can be remeasured after the training and prepared or aggregated analogously to the training dataset, wherein a label may be omitted. The calculation of the threshold value in this case depends on the selection of the animal a score or anomaly value. In particular, an anomaly score can be calculated depending on the model type, the anomaly score typically being scaled in practice in an interval between 0 and 1 in order to establish comparability. Other models classify the input data in binary fashion and generate a label anomaly or no anomaly, for example with 0 and 1. A higher anomaly score signals a greater deviation from a normal state of one of the conveyor elements and thus corresponds to a higher probability for a malfunction and thus a stoppage of the conveyor system 1. This can therefore advantageously be prevented by way of the method.

The result is therefore additional advantages relating to the targeted prevention of a system malfunction, for example the generation of meaningful data that are characteristic of operation of the conveyor system 1 or a similarly structured model purely through data aggregation in the form of measuring to generate the respective data telegram. It is also possible to transfer to different system types or conveyor systems. The costs may be particularly low because hardware costs are low or non-existent due to clever utilization of the programmable logic controllers and electronic computing devices that are already installed. Furthermore, usage irrespective of manufacturer is possible since parameter data or parameter values of a wide range of components and thus from different manufacturers can be used together. This also results in an advantageous usage in the start-up of new conveyor systems because a faster reduction of arising faults is made possible.

The method presented and the conveyor system 1 presented can be used to provide predictive maintenance in a particularly advantageous manner.

### LIST OF REFERENCE SIGNS

1 Conveyor system
2 Conveyor element
3 Assembly line tray
4 Component
5 Conveying path
6 Sensor device
7 Control device
8 Electronic computing device
9 Drive wheel
10 Guide rollers
11 Lifting table
12 Drive
13 Ground level
S1 First step
S2 Second step
S3 Third step
SA Fourth step
S5 Fifth step
S6 Sixth step

1.-9. (canceled)

10. A method for operating a conveyor system, in which assembly line trays, each of which are configured to hold a component, and are configured to be conveyed along a conveying path by stationary conveyor elements, the method comprising:
recording a respective conveying time for a respective conveyor device during a conveying process of each of the assembly line trays;
a sensor device measuring, for a respective conveyor element at the respective conveying time, at least one respective parameter value, which characterizes a state of the respective conveyor element and/or the assembly line tray conveyed by the respective conveyor element during the conveying process;
a respective control device of the respective conveyor element forming a respective data telegram for the respective conveyor element at the respective conveying time, the data telegram comprising the at least one respective parameter value, the conveying time, an assembly line tray ID of the respectively conveyed assembly line tray and/or a conveyor element ID of the respective conveyor element;
a central electronic computing device compiling the data telegrams to form a dataset:
evaluating the dataset by way of an anomaly model, which is configured to evaluate an anomaly of the at least one respective parameter value of the respective data telegram;
if the evaluation reveals that an anomaly of at least one of the parameter values is above a threshold value: issuing a service instruction for a corresponding assembly line tray and/or a corresponding conveyor element having the anomaly.

11. The method according to claim 10,
wherein the dataset and/or an additional dataset is used as a training dataset for the anomaly model, which uses a machine learning method.

12. The method according to claim 10,
wherein an active current and/or a temperature is measured as the at least one parameter value.

13. The method according to claim 10,
wherein the respective conveyor element is used to convey a drive, configured as an electric motor.

14. The method according to claim 13,
wherein an average active current and/or a maximum active current and/or a variance of the active current for a respective associated drive is measured for the respective data telegram.

15. The method according to claim 10,
wherein the respective data telegram goes through preprocessing before and/or for a compilation of the dataset.

16. The method according to claim 15,
wherein during preprocessing, a time interval is set and/or, in a case of multiple parameter values, one of the parameter values is selected and/or targets are set.

17. The method according to claim 10,
wherein the threshold value is adjusted to an anomaly value.

18. A conveyor system comprising stationary conveyor elements and assembly line trays, which are used to hold a respective component and which can be conveyed by the conveyor elements along a conveying path, wherein the conveyor system is configured to be operated by a method according to claim 10.
